(19) United States
(12) Patent Application Publication
(10) Pub. No.: US 2026/0289295 A1
(43) Pub. Date: Sep. 24, 2026

(54) SELF-ADAPTIVE CONTINUAL LEARNING METHOD AND APPARATUS BASED ON COMPLEX-NETWORK PROPERTIES

(71) Applicant: ELECTRONICS AND TELECOMMUNICATIONS RESEARCH INSTITUTE, Daejeon (KR)

(72) Inventors: Cheol Ho Kim, Daejeon (KR); JUNGHOON LEE, Daejeon (KR); Hyun Woo Kim, Daejeon (KR); Hwa Jeon Song, Daejeon (KR); Younghwan SHIN, Daejeon (KR); Jeongmin Yang, Daejeon (KR); Byunghyun Yoo, Daejeon (KR); Euisok Chung, Daejeon (KR)

(21) Appl. No.: 19/408,966

(22) Filed: Dec. 4, 2025

(30) Foreign Application Priority Data
Mar. 20, 2025 (KR) 10-2025-0036033

(51) Int. Cl. G06N 3/08

(52) U.S. Cl. CPC G06N 3/08

(57) ABSTRACT

A self-adaptive continual learning method and apparatus that reflect the small-world property and the scale-free property appearing in a complex network, in an ANN structure, are provided. A self-adaptive continual learning apparatus based on complex-network properties includes an adaptive network configurator configured to analyze the properties of an inputted current dataset, and generate an initial fully-connected MLP structure suitable for the current dataset; and a structure reconfigurator configured to receive initial fully-connected MLP network information, reconstruct the MLP structure, and output a reconstructed MLP. Accordingly, it is possible to efficiently optimize the connectivity and hierarchical structure of a network so that complexity and computational costs do not increase excessively when network extension is continuously performed in a continual learning environment.

### CROSS-REFERENCE TO RELATED APPLICATION

The present application claims priority to and the benefit of Korean patent application no. 10-2025-0036033, filed on Mar. 20, 2025, in the Korean intellectual property office, the entire disclosure of which is incorporated herein by reference.

### BACKGROUND

### 1. Technical Field

The present disclosure relates to a self-adaptive continual learning method and apparatus based on complex-network properties.

### 2. Description of Related Art

Continual learning or incremental learning is a technique that enables an artificial neural network (ANN) to continuously learn in response to continuously and newly provided data or changes in the environment, and is becoming an important research field, particularly in artificial intelligence (AI) systems where real-time information flow is essential. Conventional artificial neural networks have the problem of being difficult to adapt to additional learning or environmental changes after being learned mainly on fixed datasets. To overcome this, various continual learning techniques and structures have been proposed, but several limitations still exist. Conventional continual learning schemes include the following approaches.

Transfer learning is a scheme of relearning a pre-learned model to fit new data, so that a network can utilize information learned from existing data for new learning. However, this scheme is effective only when there is a high degree of correlation between new data and existing data, and if data distribution changes significantly, problems of overfitting or catastrophic forgetting may occur.

Rehearsal or replay is a scheme of solving the problem of catastrophic forgetting by storing some important data and using it for learning when needed. This scheme has the disadvantage that memory management is essential and computational costs increase as the amount of stored data increases.

Weight regularization is a method of preventing loss of previously learned information by fixing previously learned weights or limiting weight changes when learning new data during a continual learning process. To achieve this, a specific regularization term is added to weights so that the weights may be fixed to the values learned in previous learning or may change only within a limited range. Although this method is effective in preventing catastrophic forgetting and preserving previously learned information, by limiting the degrees of freedom of all weights in continual learning, the method may cause problems such as slow adaptation to new information or deterioration in learning performance.

Node Expansion is a method of adding new nodes (neurons) to an existing learned neural network structure so that new data can be learned in a manner independent of previous information. This method uses a scheme of gradually adding nodes or layers for new learning in order to reduce the impact of learning new data on the existing network structure. This allows existing learning data and new learning data to be learned independently within the network, and allows easy adaptation to new information while preserving existing information. This method has the advantage of providing the flexibility of a neural network to fit continuously increasing data, but, as the additions of nodes and layers accumulate, the structure of the network becomes larger and more complex. This will significantly increase the amounts of computational resource consumption and memory usage, and may adversely affect learning and inference speed.

### SUMMARY

The conventional art for effectively realizing continual learning has the problem of increasing computational resources and complexity. That is to say, the method of maintaining memory for relearning or adding nodes for new learning has the problem that computational resources and the complexity of a network increase significantly over time. The conventional art also has limitations in self-adaptation. In other words, conventional artificial neural networks have limitations in self-adapting to various changes in external environment due to their fixed structure and learning method. Due to their properties to excessively preserve previously learned knowledge, they have limitations in learning new data, and have limitations in effectively adapting to new data when the new data is significantly different from existing data.

An object of the present disclosure is to provide an artificial neural network (ANN) structure and a learning method and apparatus that effectively realize continual learning, so that a network may self-adapt to new information and maintain existing learned knowledge even in a continuous flow of data. In particular, an object of the present disclosure is to maximize learning efficiency by improving self-adaptability even in continual data learning environment and solving the problem of catastrophic forgetting.

A self-adaptive continual learning apparatus based on complex-network properties according to an embodiment of the present disclosure includes: an adaptive network configurator configured to analyze the properties of an inputted current dataset, and generate an initial fully-connected MLP structure suitable for the current dataset; and a structure reconfigurator configured to receive initial fully-connected MLP network information, reconstruct the MLP structure, and output a reconstructed MLP.

The structure reconfigurator may include a complexity metrics analyzer. The structure reconfigurator reconstructs the MLP structure by utilizing at least any one of rewiring, pruning and extension. The complexity metrics analyzer quantitatively evaluates whether a reconstructed network satisfies small-world property or scale-free property metrics. The structure reconfigurator generates the reconstructed MLP by performing optimization so that the metrics derived by the complexity metrics analyzer are within a predefined range.

In an embodiment, the self-adaptive continual learning apparatus based on complex-network properties of the present disclosure may further include a model validator configured to use a validation dataset to check whether the reconstructed MLP is able to sufficiently express data.

In an embodiment, the model validator includes: a performance evaluator configured to quantify the performance of a model by comparing a predicted value and an actual value and calculating a loss function or accuracy; and a diversity analyzer configured to analyze diversity to ensure diversity between two or more models.

In an embodiment, when the reconstructed MLP does not satisfy target performance, the model validator may feed back corresponding information to the structure reconfigurator to retry a reconstruction task.

In an embodiment, the self-adaptive continual learning apparatus based on complex-network properties of the present disclosure further includes an ensemble coordinator configured to construct ensemble models from models that are transmitted from the model validator and have passed validation. The ensemble models include a plurality of selected models that are included in a final prediction model and one or more candidate models that are not included in the final prediction model. The ensemble coordinator generates a prediction model network, which is a final prediction model for the current dataset, using the plurality of selected models.

In an embodiment, the self-adaptive continual learning apparatus based on complex-network properties of the present disclosure further includes a prediction evaluator configured to evaluate the result of a prediction performed by applying a test dataset to the prediction model network.

An evaluation result in the prediction evaluator may be transmitted to the ensemble coordinator. The ensemble coordinator attempts improvement in such a way to coordinate an ensemble construction or utilize unused candidate models according to the evaluation result.

An evaluation result in the prediction evaluator may be transmitted to the structure reconfigurator. The structure reconfigurator performs improvement through model reconstruction according to the evaluation result.

A self-adaptive continual learning method based on complex-network properties according to an embodiment of the present disclosure includes: an adaptive network configuring step of analyzing the properties of an inputted current dataset, and generating an initial fully-connected MLP structure suitable for the current dataset; and a structure reconstructing step of receiving initial fully-connected MLP network information, reconstructing the MLP structure, and outputting a reconstructed MLP.

In an embodiment, the structure reconstructing step may include: a step of reconstructing an MLP structure by utilizing at least any one of rewiring, pruning and extension; a complex network metrics analyzing step of quantitatively evaluating whether a reconstructed network satisfies small-world property or scale-free property metrics; and a step of generating the reconstructed MLP by performing optimization so that metrics derived from the complex network metrics analyzing step are within a predefined range.

In an embodiment, the self-adaptive continual learning method based on complex-network properties of the present disclosure further includes a model validating step of using a validation dataset to check whether the reconstructed MLP is able to sufficiently express data.

In an embodiment, the model validating step includes: a performance evaluating step of quantifying the performance of a model by comparing a predicted value and an actual value to calculate a loss function or accuracy; and a diversity analyzing step of analyzing diversity to ensure diversity between two or more models.

In an embodiment, the model validating step may further include a step of feeding back corresponding information to the structure reconstructing step when the reconstructed MLP does not satisfy target performance, to retry a reconstruction task.

In an embodiment, the self-adaptive continual learning method based on complex-network properties of the present disclosure further includes an ensemble coordinating step of constructing ensemble models from models that have passed validation of the model validating step. The ensemble models include a plurality of selected models that are included in a final prediction model and one or more candidate models that are not included in the final prediction model. The ensemble coordinating step may include a step of generating a prediction model network, which is a final prediction model for the current dataset, using the plurality of selected models.

In an embodiment, the self-adaptive continual learning method based on complex-network properties of the present disclosure further includes a prediction evaluating step of evaluating the result of a prediction performed by applying a test dataset to the prediction model network.

In an embodiment, an evaluation result in the prediction evaluating step is transmitted to the ensemble coordinating step. The ensemble coordinating step further includes a step of attempting improvement by coordinating an ensemble construction or utilizing unused candidate models according to the evaluation result.

In an embodiment, an evaluation result in the prediction evaluating step is transmitted to the structure reconstructing step. The structure reconstructing step further includes a step of performing improvement through model reconstruction according to the evaluation result.

According to the present disclosure, by simultaneously improving resistance to the problem of catastrophic forgetting, self-adaptation, the efficiency of a network and the efficiency of computational resources, a reliable artificial neural network (ANN) structure capable of exhibiting excellent learning performance in various real environments is provided.

According to the present disclosure, the ‘small-world property’ and the ‘scale-free property’ that appear in complex networks such as biological neural networks or social networks are reflected in an ANN structure, and these properties are induced to be maintained even when learning new data, thereby minimizing the problem of catastrophic forgetting by maintaining existing learning information. This enables the ANN to maintain learned knowledge for a long period of time without loss even in various environmental changes.

According to the present disclosure, even when new data learning is performed, by inducing an ANN structure to satisfy specific complex-network properties, a network may self-adapt to changes in external environment even while preserving existing knowledge. This enables the ANN to learn efficiently and flexibly in a dynamic data environment.

According to the present disclosure, measures capable of efficiently optimizing the connectivity and hierarchical structure of a network so that complexity and computational costs do not increase excessively when network extension is continuously performed in a continual learning environment are provided. This enables the ANN to maintain efficiency in long-term learning.

The ANN structure of the present disclosure is designed to be applicable to various application fields requiring continuous data flow, such as autonomous driving, smart manufacturing, intelligent agents and healthcare data analysis, thereby enabling exhibition of optimal performance in real-time AI applications that demand continual learning.

According to the present disclosure, a non-transitory computer readable medium containing program instructions executed by a processor, the computer readable medium comprising: program instructions that analyze the properties of an inputted current dataset, and generate an initial fully-connected MLP structure suitable for the current dataset; and program instructions that receive initial fully-connected MLP network information, reconstruct the MLP structure, and output a reconstructed MLP.

Effects of the present disclosure are not limited to those mentioned above, and other effects not mentioned will be clearly understood by those skilled in the art from the description below.

### BRIEF DESCRIPTION OF THE DRAWINGS

FIG. 1 is a diagram illustrating a fully-connected MLP with two hidden layers and an MLP with connections changed through rewiring.

FIG. 2 is a graph showing the relationship between rewiring probability, clustering coefficient, and shortest path.

FIG. 3 is a diagram schematically illustrating a continual learning process according to the present disclosure by taking MLPs as an example.

FIG. 4 is a block diagram illustrating the configuration of a self-adaptive continual learning apparatus based on complex-network properties according to an embodiment of the present disclosure.

FIG. 5 is a diagram illustrating a specific process of the present disclosure, with solid arrows representing a forward process and dashed arrows representing a feedback process.

FIG. 6 is a flowchart showing the operation flow of a self-adaptive continual learning method based on complex-network properties according to an embodiment of the present disclosure.

### DETAILED DESCRIPTION

The above-described aspects, other aspects, advantages and features of the present disclosure and methods of achieving them will be apparent from the following description of embodiments described below in detail in conjunction with the accompanying drawings.

However, the present disclosure is not limited to embodiments set forth herein but may be embodied in many different forms and these embodiments are merely provided to help those of ordinary skill in the art understand aspects, configuration, and effects of the present disclosure. Therefore, the scope of the present disclosure is defined by the description of claims.

The terms used herein are for the purpose of describing embodiments only and are not intended to be limiting of the present disclosure. As used herein, singular forms are intended to include plural forms unless the context clearly indicates otherwise. As used herein, the terms “comprise” and/or “comprising” specify the presence of stated components, steps, operations and/or elements but do not preclude the presence or addition of one or more other components, steps, operations and/or elements.

In the present disclosure, the properties of well-known complex networks are applied to artificial neural networks (ANNs) to increase self-adaptation, reduce the problem of catastrophic forgetting and at the same time efficiently manage the complexity of a network during continual learning. The ‘small-world property’ and the ‘scale-free property’ found in complex networks such as biological neural networks and social networks enable biological neural networks to achieve efficient information transmission and learning. In the present disclosure, the properties of such complex networks are introduced into artificial neural networks.

The present disclosure adopts a scheme in which an artificial neural network suitable for a dataset and metadata given for the first time in a continual learning environment is selected as a basic structure and then, through processes such as rewiring, pruning and structural extension including node expansion, the structure of the artificial neural network is changed so that a model itself has optimal complex-network properties, thereby allowing the model to adapt to new data and environments.

A method for achieving the object of the present disclosure may be generally applied to general artificial neural networks (ANNs), but, for effective explanation, will be described using a fully-connected multi-layer perceptron (MLP) structure, which is the basic form of an artificial neural network. As is well known, this structure does not have the small-world property or the scale-free property. However, by reconstructing the structure through appropriate rewiring, it is possible to generate a network with the small-world property or the scale-free property.

A small-world network means a network with a short average path length and a high clustering coefficient. The small-world network is defined by the following two main attributes. 1. Short average path length (L)

An average path length is the average of the shortest path lengths between any two nodes in a network, and may be expressed in a formula as follows.

$$L = \frac{1}{N ( N - 1 )} {\sum }_{i \neq j} {d}_{i j}$$

Here, dᵢⱼ is the shortest path length between nodes i and j, and N is the total number of nodes in the network.

### 2. High Clustering Coefficient (C)

A clustering coefficient represents the probability that the neighbors of a node are connected to each other. A clustering coefficient Cᵢ of a node i is defined as follows.

$${C}_{i} = \frac{2 {e}_{i}}{{k}_{i} ( {k}_{i} - 1 )}$$

Here, eᵢ is the number of actual edges that exist between the neighbors of the node i, and k is the number of neighbors of the node i. The total clustering coefficient C of a network is defined as an average over all nodes as follows.

$$C = \frac{1}{N} {\sum }_{i = 1}^{N} {C}_{i}$$

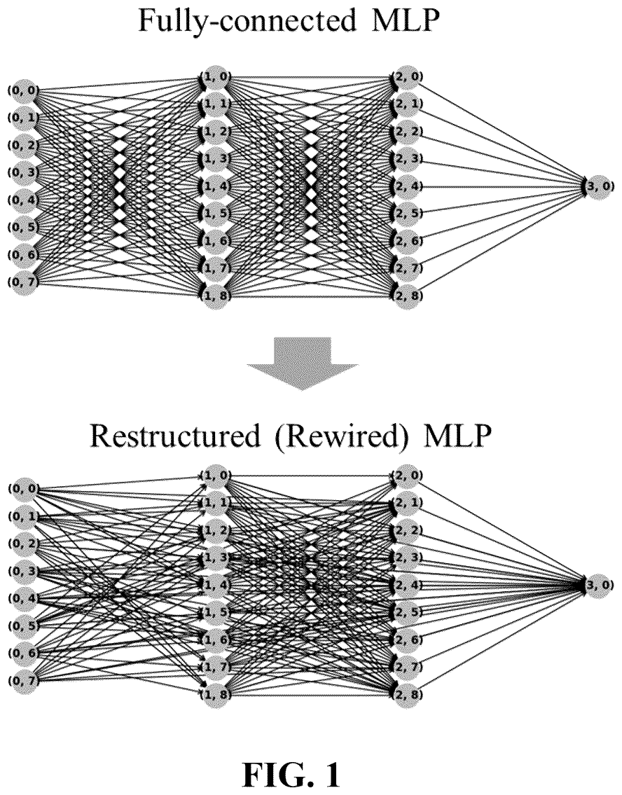

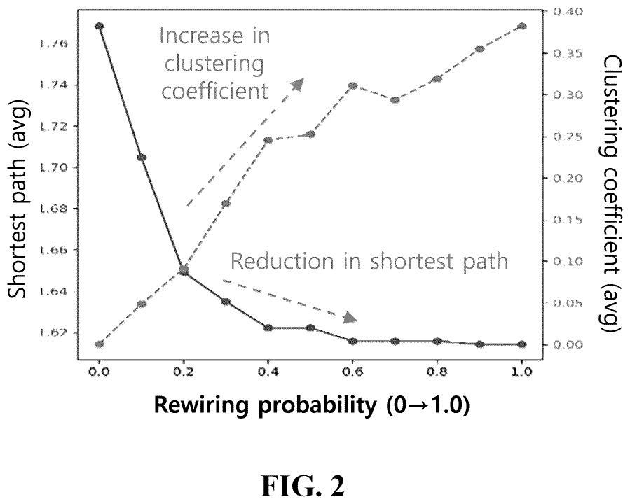

A fully-connected MLP generally does not have the small-world property, but may be changed to have a short average path length and a high clustering coefficient through appropriate rewiring. The upper network of FIG. 1 is a fully-connected MLP with two hidden layers, and the lower network of FIG. 1 is an MLP with connections changed through rewiring. Referring to FIG. 2, it may be seen that, as the rewiring probability is increased, the lower MLP has a larger clustering coefficient and a smaller shortest path length compared to the upper MLP, thereby being closer to the small-world property.

A scale-free network refers to a network in which the degree of connectivity of nodes follows a power-law distribution. This is defined by the following characteristics.

### 1. Power-Law Distribution:

The degree K of connectivity of nodes follows a probability density function P(k), which is expressed as follows.

$$P ( k ) ∼ {k}^{- γ}$$

Here, γ is a power-law exponent, and is generally 2<γ<3.

### 2. Preferential Attachment:

When a new node is connected to an existing network, the new node is connected with a high probability to a node that already has a high degree of connectivity. This may be expressed by the following formula.

$$\prod ( {k}_{i} ) = \frac{{k}_{i}}{{\sum }_{j} {k}_{j}}$$

Here, π(kᵢ) is the probability that a new node is connected to a node i, and kᵢ is the current degree of connectivity of the node i.

A scale-free network has a characteristic that a very small number of hub nodes have a large number of connections whereas most nodes have a small number of connections. Due to this, the network has high resilience.

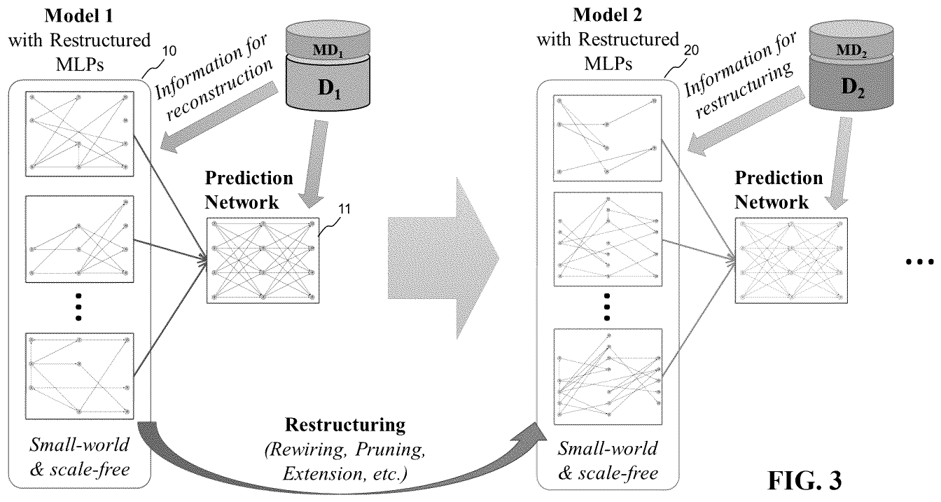

FIG. 3 is a diagram schematically illustrating a continual learning process according to the present disclosure by taking MLPs as an example. In a continual learning environment, different datasets are inputted sequentially, and are denoted by D₁, D₂, . . . . First, when receiving a first dataset D₁ as an input, metadata MD₁ related to data is extracted from the data or separate metadata is received together. Based on this, a fully-connected MLP serving as a foundation is constructed. Through appropriate processes such as rewiring, pruning and node expansion, the MLP is restructured to have the small-world property and the scale-free property. Through this process, various candidates of the restructured MLP may be generated, and, by combining these models, a first ensemble inference model (Model 1) 10 may be generated. In this process, better performance may be expected by utilizing a separate prediction network 11.

Now, a situation in which a new dataset D₂ is inputted and the dataset D₁ is no longer accessible is assumed. Learning on new data starts from a model built in a previous stage. Information necessary for reconstruction of a model is extracted from D₂, and, based on this, whether to use the previously constructed model 1 10 as it is or partial changes are necessary is examined. If the properties of the dataset D₂ or the information of metadata MD₂ are significantly different from the dataset D₁ and the metadata MD₁, more changes should be made. As an example of making a change, there is a method of removing, among members that constitute the model 1 10, members that have difficulty in learning the dataset D₂ and replacing the model 1 10 with a reconstructed MLP model generated based on the dataset D₂. As another example, there is a method of applying additional reconstruction methods (rewiring, pruning, structure expansion, etc.) to the model 1 10 to find an appropriate structure for learning of the dataset D₂. However, all reconstructions should always evaluate complex-network property metrics and ensure that these complex-network property metrics satisfy appropriate conditions.

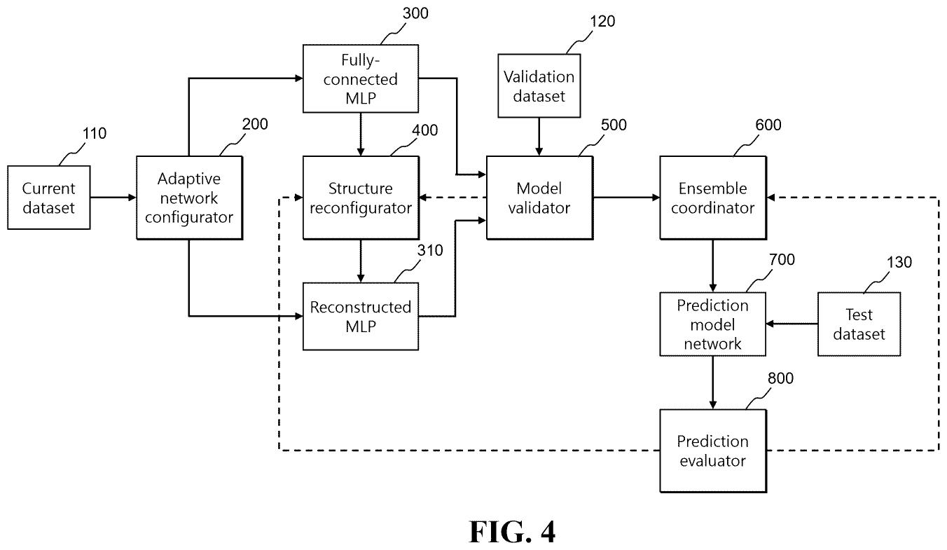

FIG. 4 is a block diagram illustrating the configuration of a self-adaptive continual learning apparatus according to an embodiment of the present disclosure. In FIG. 4, solid arrows represent a forward process, and dashed arrows represent a feedback process.

The apparatus of the present disclosure operates in a continual learning environment. In the continual learning environment, a dataset is provided in the form of a data stream or a plurality of datasets. It is assumed that, while learning a current dataset 110, a next dataset cannot be identified and access to a previous dataset is also limited. However, as the occasion demands, some data may be stored in memory and be reused. The current dataset 110 may be provided in the form of a dataset and metadata. Metadata may include various information on a dataset, such as task information, a variable list, the numbers of variables and instances, key statistics for each variable, the name of a target variable, an encoding rule, etc.

An adaptive network configurator 200 analyzes the properties of an inputted dataset, and generates the structure of an initial fully-connected MLP 300 suitable for the corresponding dataset.

A structure reconfigurator 400 receives initial MLP network information, reconstructs the MLP structure, and outputs a reconstructed MLP 310. Rewiring, pruning and extension may be utilized in reconstructing the MLP structure.

The structure reconfigurator 400 may include a complexity metrics analyzer 440. The complexity metrics analyzer 440 quantitatively evaluates whether a reconstructed network satisfies metrics intended in the present disclosure, such as the small-world property or the scale-free property. The structure reconfigurator 400 performs optimization so that the metrics derived by the complexity metrics analyzer 440 fall within a predefined range, thereby generating a reconstructed MLP 310.

A Model validator 500 validates whether the reconstructed MLP 310 may sufficiently express data. The model validator 500 uses a validation dataset 120 to evaluate performance and analyze diversity. The validation dataset 120 may utilize a part of current data or include some data stored from past data.

The model validator 500 may include a performance evaluator 510 and a diversity analyzer 520. The performance evaluator 510 quantifies the performance of a model by comparing a predicted value and an actual value and calculating a loss function or accuracy. In an embodiment, the diversity analyzer 520 may analyze diversity by utilizing metrics such as disagreement measures and Q-statistics to ensure diversity between two or more models. In addition to the disagreement measures and the Q-statistics, various metrics may be used as metrics for diversity analysis.

If the reconstructed MLP does not satisfy target performance, the model validator 500 feeds back corresponding information to the structure reconfigurator 400 to cause a reconstruction task to be retried. According to an embodiment, when optimization at an earlier stage than this is required, the model validator 500 may transmit feedback information up to the adaptive network configurator 200, thereby achieving a deeper level of improvement in such a way to enable changes to the initial MLP structure.

The model validator 500 transmits models that have passed validation to an ensemble coordinator 600. The ensemble coordinator 600 constructs ensemble models. The ensemble models may include a plurality of selected models that are included in a final prediction model, and one or more candidate models that are not included in the final prediction model. The ensemble coordinator 600 uses the selected models to generate a prediction model network 700, which is a final prediction model for the current dataset 110. In an embodiment, the ensemble coordinator 600 may generate the prediction model network 700 by using the selected models to assign appropriate weights to respective models and connecting them to a separate fully-connected network.

A prediction evaluator 800 evaluates the result of a prediction performed by applying a test dataset 130 to the prediction model network 700. The test dataset 130 may include only test data, or, as the occasion demands, may include metadata for a test.

The evaluation result for the prediction in the prediction evaluator 800 may contribute to model improvement through two feedback paths. A first feedback is transmitted to the ensemble coordinator 600, and the ensemble coordinator 600 attempts improvement by coordinating an ensemble construction or utilizing unused candidate models according to the evaluation result for the prediction. A second feedback is transmitted to the structure reconfigurator 400, and the structure reconfigurator 400 performs deep-level improvement through model reconstruction according to the evaluation results for the prediction. The present disclosure may also be applied to a single model rather than an ensemble model. A single model may be considered as a case where there is only one model that constructs an ensemble.

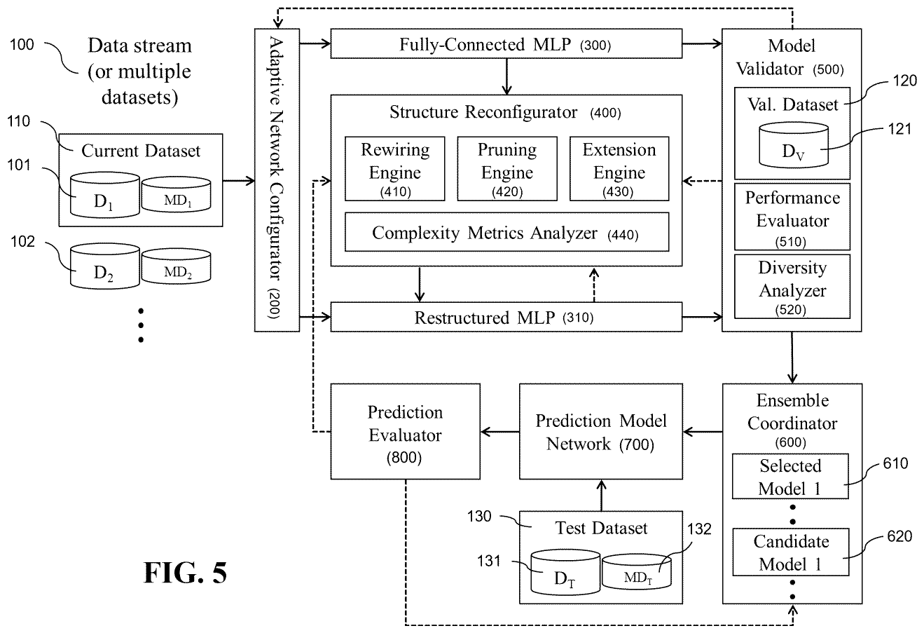

FIG. 5 is a diagram illustrating a specific process of the present disclosure. Solid arrows represent a forward process, and dashed arrows represent a feedback process. The functions of respective components and a process will be described below.

### 1. Continual Learning Environment

In a continual learning environment, a dataset 100 is provided in the form of a data stream or a plurality of datasets. It is assumed that, while learning a current dataset 110, a next dataset cannot be identified and access to a previous dataset is limited as well. However, as the occasion demands, some data may be stored in memory and be reused. For example, some of past data may be stored to further solve the problem of catastrophic forgetting or to generate a validation dataset for model optimization. This scheme is a method that is employed in continual learning using rehearsal or replay techniques.

### 2. Dataset and Metadata

The current dataset 110 is provided in the form of a dataset and metadata 101, and metadata may be omitted as the case may be. Metadata may include various information on a dataset, such as task information, a variable list, the numbers of variables and instances, key statistics for each variable, the name of a target variable, an encoding rule, etc.

### 3. Initial Network Construction

The dataset and metadata 101 are inputted to the adaptive network configurator 200. The adaptive network configurator 200 analyzes the properties of an input dataset, and generates the structure of an initial fully-connected MLP 300 suitable for the corresponding dataset.

### 4. Structure Reconstruction

The structure reconfigurator 400 receives initial MLP network information and reconstructs the MLP structure using a rewiring engine 410, a pruning engine 420 and an extension engine 430.

### 5. Analysis of Complex-Network Properties

The complexity metrics analyzer 440 quantitatively evaluates whether a reconstructed network satisfies metrics intended in the present disclosure, such as the small-world property or the scale-free property. The structure reconfigurator 400 performs optimization so that the metrics derived by the complexity metrics analyzer 440 fall within a predefined range, and as a result, generates a reconstructed MLP 310.

### 6. Reconstructed Model Validation

The model validator 500 is used to check whether a reconstructed MLP is able to sufficiently express data. The model validator 500 includes the validation dataset 120, the performance evaluator 510, and the diversity analyzer 520. The validation dataset 120 may utilize a part of current data or include some data stored from past data as described above.

### 7. Performance Evaluation and Diversity Analysis

The performance evaluator 510 quantifies the performance of a model by comparing a predicted value and an actual value and calculating a loss function or accuracy. The diversity analyzer 520 analyzes diversity by utilizing metrics such as disagreement measures and Q-statistics to ensure diversity between two or more models.

### 8. Reconstruction Through Feedback

If the reconstructed MLP does not satisfy target performance, corresponding information is fed back to the structure reconfigurator 400 to retry a reconstruction task. When optimization at an earlier stage than this is required, feedback information is transmitted up to the adaptive network configurator 200, thereby achieving a deeper level of improvement in such a way to enable changes to the initial MLP structure.

### 9. Ensemble Construction and Management

Models that have passed validation are transmitted to the ensemble coordinator 600 to construct ensemble models. The ensemble models are divided into a plurality of selected models 610 that are included in a final prediction model and a plurality of candidate models 620 that are not included in the final prediction model.

### 10. Final Prediction Model

The prediction model network 700, which is a final prediction model for the current dataset 110, is generated. One method of generating a prediction model network is to use the selected models 610 of the ensemble coordinator 600 to assign appropriate weights to respective models and connect them to a separate fully-connected network.

### 11. Evaluation of Prediction Result

The test dataset 130 is applied to the prediction model network 700 to perform prediction, and the result is analyzed through the prediction evaluator 800. The test dataset 130 may include only test data 131, or, as the occasion demands, may include metadata 132 for a test.

### 12. Feedback Process

The evaluation result for prediction contributes to model improvement through two feedback paths. A first feedback is transmitted to the ensemble coordinator 600 to attempt improvement by coordinating an ensemble construction or utilizing unused candidate models 620. A second feedback is transmitted to the structure reconfigurator 400 to perform deep-level improvement through model reconstruction.

Although the above description assumes an ensemble model, the case of a single model may be included. A single model may be considered as a case where there is only one model that constructs an ensemble.

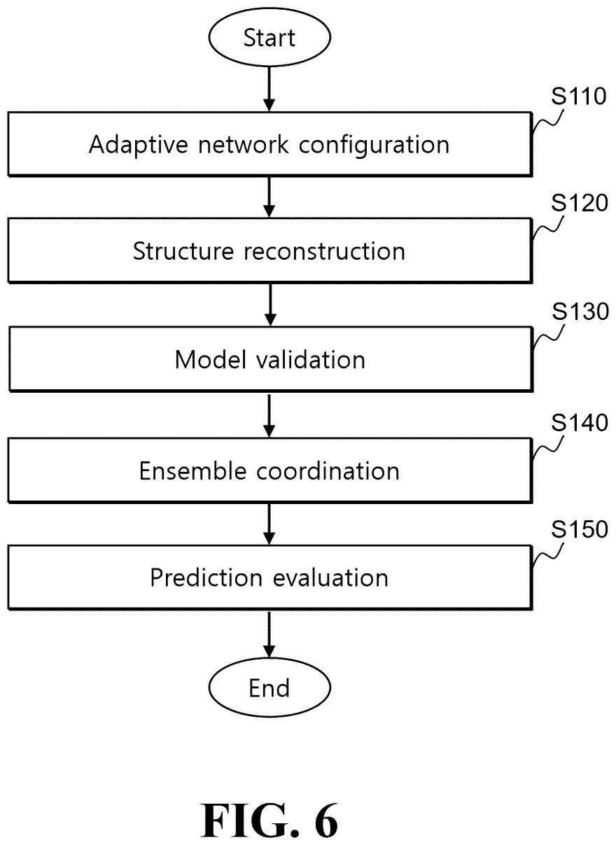

FIG. 6 is a flowchart showing the operation flow of a self-adaptive continual learning method based on complex-network properties according to an embodiment of the present disclosure.

A self-adaptive continual learning method based on complex-network properties according to an embodiment of the present disclosure includes an adaptive network configuring step S110 of analyzing the properties of an inputted current dataset to generate an initial fully-connected MLP structure suitable for the current dataset; a structure reconstructing step S120 of receiving initial fully-connected MLP network information, reconstructing the MLP structure and outputting a reconstructed MLP; a model validating step S130 of using a validation dataset to check whether the reconstructed MLP is able to sufficiently express data; an ensemble coordinating step S140 of constructing ensemble models from models that have passed validation of the model validating step; and a prediction evaluating step S150 of evaluating the result of a prediction performed by applying a test dataset to a prediction model network.

The structure reconstructing step S120 may include a step of reconstructing an MLP structure by utilizing at least any one of rewiring, pruning and extension; a complex network metrics analyzing step of quantitatively evaluating whether a reconstructed network satisfies small-world property or scale-free property metrics; and a step of generating the reconstructed MLP by performing optimization so that the metrics derived from the complex network metrics analyzing step are within a predefined range.

The model validating step S130 includes a performance evaluating step of quantifying the performance of a model by comparing a predicted value and an actual value to calculate a loss function or accuracy; and a diversity analyzing step of analyzing diversity by utilizing at least any one metric of a disagreement measure and Q-statistics to ensure diversity between two or more models.

The model validating step S130 may feed back corresponding information to the structure reconstructing step when the reconstructed MLP does not satisfy target performance, to retry a reconstruction task.

The ensemble models may include a plurality of selected models that are included in a final prediction model and one or more candidate models that are not included in the final prediction model. The ensemble coordinating step S140 may further include a step of generating a prediction model network, which is a final prediction model for the current dataset, using the plurality of selected models.

An evaluation result in the prediction evaluating step S150 may be transmitted to the ensemble coordinating step S140. The ensemble coordinating step S140 may further include a step of attempting improvement by coordinating an ensemble construction or utilizing unused candidate models according to the evaluation result.

The evaluation result in the prediction evaluating step S150 may also be transmitted to the structure reconstructing step S120. The structure reconstructing step S120 may perform improvement through model reconstruction according to the evaluation result.

The method according to an embodiment of the present disclosure may be implemented in the form of program instructions that may be executed through various computer means, and may be recorded on a computer-readable medium.

The computer-readable medium may include program instructions, data files, data structures, etc., alone or in combination. The program instructions recorded on the computer-readable medium may be specially designed and configured for embodiments of the present disclosure, or may be known and available to those skilled in the art of computer software. A computer-readable recording medium may include a hardware device configured to store and perform program instructions. For example, the computer-readable recording medium may be magnetic media such as hard disks, floppy disks and magnetic tapes, optical media such as CD-ROMs and DVDs, magneto-optical media such as floptical disks, ROMs, RAMs, flash memory, etc. Program instructions may include not only machine language codes, such as those produced by a compiler, but also high-level language codes that may be executed by a computer through an interpreter or the like.

Although embodiments of the present disclosure have been described above in detail, the scope of the present disclosure is not limited thereto, and various modifications and improvements made by those skilled in the art using the basic concept of the present disclosure defined in the following claims also fall within the scope of the present disclosure.

What is claimed is:

1. A self-adaptive continual learning apparatus based on complex-network properties, comprising:
an adaptive network configurator configured to analyze the properties of an inputted current dataset, and generate an initial fully-connected MLP structure suitable for the current dataset; and
a structure reconfigurator configured to receive initial fully-connected MLP network information, reconstruct the MLP structure, and output a reconstructed MLP.

2. The self-adaptive continual learning apparatus based on complex-network properties according to claim 1, wherein:
the structure reconfigurator comprises a complexity metrics analyzer,
the structure reconfigurator reconstructs the MLP structure by utilizing at least any one of rewiring, pruning and extension,
the complexity metrics analyzer quantitatively evaluates whether a reconstructed network satisfies small-world property or scale-free property metrics, and
the structure reconfigurator generates the reconstructed MLP by performing optimization so that the metrics derived by the complexity metrics analyzer are within a predefined range.

3. The self-adaptive continual learning apparatus based on complex-network properties according to claim 2, further comprising:
a model validator configured to use a validation dataset to check whether the reconstructed MLP is able to sufficiently express data.

4. The self-adaptive continual learning apparatus based on complex-network properties according to claim 3, wherein the model validator comprises:
a performance evaluator configured to quantify the performance of a model by comparing a predicted value and an actual value and calculating a loss function or accuracy; and
a diversity analyzer configured to analyze diversity to ensure diversity between two or more models.

5. The self-adaptive continual learning apparatus based on complex-network properties according to claim 4, wherein, when the reconstructed MLP does not satisfy target performance, the model validator feeds back corresponding information to the structure reconfigurator to retry a reconstruction task.

6. The self-adaptive continual learning apparatus based on complex-network properties according to claim 3, further comprising:
an ensemble coordinator configured to construct ensemble models from models that are transmitted from the model validator and have passed validation,
wherein the ensemble models include a plurality of selected models that are included in a final prediction model and one or more candidate models that are not included in the final prediction model, and
wherein the ensemble coordinator generates a prediction model network, which is a final prediction model for the current dataset, using the plurality of selected models.

7. The self-adaptive continual learning apparatus based on complex-network properties according to claim 6, further comprising:
a prediction evaluator configured to evaluate the result of a prediction performed by applying a test dataset to the prediction model network.

8. The self-adaptive continual learning apparatus based on complex-network properties according to claim 7, wherein:
an evaluation result in the prediction evaluator is transmitted to the ensemble coordinator, and
the ensemble coordinator attempts improvement in such a way to coordinate an ensemble construction or utilize unused candidate models according to the evaluation result.

9. The self-adaptive continual learning apparatus based on complex-network properties according to claim 7, wherein:
an evaluation result in the prediction evaluator is transmitted to the structure reconfigurator, and
the structure reconfigurator performs improvement through model reconstruction according to the evaluation result.

10. A self-adaptive continual learning method based on complex-network properties, comprising:
an adaptive network configuring step of analyzing the properties of an inputted current dataset, and generating an initial fully-connected MLP structure suitable for the current dataset; and
a structure reconstructing step of receiving initial fully-connected MLP network information, reconstructing the MLP structure, and outputting a reconstructed MLP.

11. The self-adaptive continual learning method based on complex-network properties according to claim 10, wherein the structure reconstructing step comprises:
a step of reconstructing an MLP structure by utilizing at least any one of rewiring, pruning and extension;
a complex network metrics analyzing step of quantitatively evaluating whether a reconstructed network satisfies small-world property or scale-free property metrics; and
a step of generating the reconstructed MLP by performing optimization so that metrics derived from the complex network metrics analyzing step are within a predefined range.

12. The self-adaptive continual learning method based on complex-network properties according to claim 11, further comprising:
a model validating step of using a validation dataset to check whether the reconstructed MLP is able to sufficiently express data.

13. The self-adaptive continual learning method based on complex-network properties according to claim 12, wherein the model validating step comprises:
a performance evaluating step of quantifying the performance of a model by comparing a predicted value and an actual value to calculate a loss function or accuracy; and
a diversity analyzing step of analyzing diversity to ensure diversity between two or more models.

14. The self-adaptive continual learning method based on complex-network properties according to claim 13, wherein the model validating step further comprises:
a step of feeding back corresponding information to the structure reconstructing step when the reconstructed MLP does not satisfy target performance, to retry a reconstruction task.

15. The self-adaptive continual learning method based on complex-network properties according to claim 12, further comprising:
an ensemble coordinating step of constructing ensemble models from models that have passed validation of the model validating step,
wherein the ensemble models include a plurality of selected models that are included in a final prediction model and one or more candidate models that are not included in the final prediction model, and
wherein the ensemble coordinating step comprises a step of generating a prediction model network, which is a final prediction model for the current dataset, using the plurality of selected models.

16. The self-adaptive continual learning method based on complex-network properties according to claim 15, further comprising:
a prediction evaluating step of evaluating the result of a prediction performed by applying a test dataset to the prediction model network.

17. The self-adaptive continual learning method based on complex-network properties according to claim 16, wherein:
an evaluation result in the prediction evaluating step is transmitted to the ensemble coordinating step, and
the ensemble coordinating step further comprises a step of attempting improvement by coordinating an ensemble construction or utilizing unused candidate models according to the evaluation result.

18. The self-adaptive continual learning method based on complex-network properties according to claim 16, wherein:
an evaluation result in the prediction evaluating step is transmitted to the structure reconstructing step, and
the structure reconstructing step further comprises a step of performing improvement through model reconstruction according to the evaluation result.

19. A non-transitory computer readable medium containing program instructions executed by a processor, the computer readable medium comprising:
program instructions that analyze the properties of an inputted current dataset, and generate an initial fully-connected MLP structure suitable for the current dataset; and
program instructions that receive initial fully-connected MLP network information, reconstruct the MLP structure, and output a reconstructed MLP.
